(19) United States
(12) Patent Application Publication
(10) Pub. No.: US 2022/0094003 A1
(43) Pub. Date: Mar. 24, 2022

(54) BATTERY MODULE ASSEMBLY

(71) Applicant: HYUNDAI MOBIS Co., Ltd., Seoul (KR)

(72) Inventors: Sang Chul JO, Geoje-si (KR); Jae Young JANG, Yongin-si (KR); Yong Jung KIM, Yongin-si (KR)

(73) Assignee: HYUNDAI MOBIS Co., Ltd., Seoul (KR)

(21) Appl. No.: 17/481,776

(22) Filed: Sep. 22, 2021

(30) Foreign Application Priority Data
Sep. 24, 2020 (KR) 10-2020-0124174

(51) Int. Cl. H01M 50/211; H01M 50/507; H01M 50/503; H01M 50/284; H01M 50/516

(52) U.S. Cl. CPC H01M 50/211; H01M 50/507; H01M 50/516; H01M 50/284; H01M 50/503

(57) ABSTRACT

A battery module assembly includes a cell assembly including a plurality of battery cells which are stacked and a front plate and a rear plate supporting the cell assembly in a front region and a rear region in a direction in which the plurality of battery cells are stacked. Each of the front plate and the rear plate includes an upper frame, a lower frame, and a plurality of bus bars disposed between the upper frame and the lower frame to have a tetragonal plate shape. Each of the plurality of bus bars comprises a slit groove formed in a lengthwise direction. An electrode lid unloaded from each of the plurality of battery cells is inserted into the slit groove, the inserted electrode lid is bent to be adhered to a corresponding bus bar of the plurality of bus bars, and the bent electrode lid is connected to the corresponding bus bar by a welding process in an adhered state.

### CROSS-REFERENCE TO RELATED APPLICATIONS

This application claims priority under 35 U.S.C. § 119 to Korean Patent Application No. 10-2020-0124174, filed on Sep. 24, 2020, the disclosure of which is incorporated herein by reference in its entirety.

### TECHNICAL FIELD

The present disclosure relates to a battery module assembly, and more particularly, to an electrode structure of a battery module.

### BACKGROUND

FIGS. 1 and 2 are diagrams for describing a battery module assembly of the related art.

Referring to FIGS. 1 and 2, the battery module assembly (BMA) of the related art includes a plurality of battery cells 10 and 60, a pad 20, a cartridge 30, a bus bar 40, and a printed circuit board (PCB) 50.

Each of the battery cells 10 and 60 is configured with an anode plate, a cathode plate, an electrolyte, and a separation membrane and is a minimum configuration unit of a battery. A plurality of electrode lids (or cell taps) 11 and 12 unloaded from the battery cell 10 are provided at both end portions of the battery cell 10. The electrode lids 11 and 12 include a positive electrode lid 11 and a negative electrode lid 12.

The pad 20 is disposed between two battery cells to fix the battery cells, and simultaneously, provides a certain surface pressure so that the battery cells are closely adhered to each other.

The cartridge 30 is disposed between the battery cells 10 and 60 to have a tetragonal frame shape where a center thereof is hollow, so as to fix positions of the battery cells 10 and 60, and is configured with an aluminum cover on which insulation processing has been performed.

The bus bar 40 includes a parallel bus bar (42 of FIG. 1), connecting the electrode lids of the battery cells 10 and 60 in parallel, and a serial bus bar (44 of FIG. 2) which connects the battery cells in series.

The PCB 50 transfers voltage information about the battery cell to the outside, and to this end, a plurality of electronic devices for processing the voltage information about the battery cell are mounted on the PCB 50.

The battery module assembly of the related art needs a separate bus bar for connecting the battery cells in series and parallel and needs a separate cartridge for foxing the battery cells. Also, a soldering process between a bus bar 44 and the PCB 50 is needed.

The separate elements and the soldering process are factors which increase the process (structure) complexity, cost, weight, and size of the battery module assembly.

### SUMMARY

Accordingly, the present disclosure provides a battery module assembly in which structure materials such as a bus bar and a cartridge are removed for decreasing the process (structure) complexity, cost, weight, and size of the battery module assembly.

In one general aspect, a battery module assembly includes: a cell assembly including a plurality of battery cells which are stacked; and a front plate and a rear plate supporting the cell assembly in a front region and a rear region in a direction in which the plurality of battery cells are stacked, wherein each of the front plate and the rear plate includes: an upper frame; a lower frame; and a plurality of bus bars disposed between the upper frame and the lower frame to have a tetragonal plate shape, each of the plurality of bus bars includes a slit groove extending in a lengthwise direction, and each of the plurality of battery cells includes an electrode lid inserted into the slit groove, bent to be adhered to a corresponding bus bar of the plurality of bus bars, and connected to the corresponding bus bar by a welding process in an adhered state.

In another general aspect, a battery module assembly includes: a cell assembly including a plurality of battery cells which are stacked; and a front plate and a rear plate supporting the cell assembly in a front region and a rear region in a direction in which the plurality of battery cells are stacked, wherein each of the front plate and the rear plate includes: an upper frame; a lower frame; a plurality of partition walls connecting the upper frame to the lower frame; and a plurality of bus bars disposed between the upper frame and the lower frame, having a tetragonal plate shape, and insulated by the plurality of partition walls. Each of the plurality of bus bars includes a slit groove extending in a lengthwise direction. Each of the plurality of battery cells includes an electrode lid inserted into the slit groove, bent to be adhered to a corresponding bus bar of the plurality of bus bars, and connected to the corresponding bus bar by a welding process in an adhered state. At least two of the plurality of bus bars each include an extension portion bent vertically from a lower end portion of a corresponding one of the at least two of the plurality of bus bars, for increasing a square.

Other features and aspects will be apparent from the following detailed description, the drawings, and the claims.

### BRIEF DESCRIPTION OF THE DRAWINGS

FIGS. 1 and 2 are diagrams for describing a battery module assembly of the related art.

FIG. 3 is an exploded perspective view of a battery module assembly according to an embodiment of the present disclosure.

FIG. 4 is a perspective view illustrating a unit structure of a cell assembly illustrated in FIG. 3.

FIG. 5 is a front view as a front plate illustrated in FIG. 3 is seen from a front region.

FIG. 6 is a perspective view for three-dimensionally showing a front plate illustrated in FIG. 5.

FIG. 7 is a front view of a front plate in a state where a PCB is removed.

FIG. 8 is a diagram for describing a coupling structure of a PCB and a front plate.

FIG. 9 is a diagram illustrating an example where some structure materials of a front plate illustrated in FIG. 6 have been processed.

FIGS. 10 to 12 are diagrams for describing an electrode connection structure of a bus assembly integrated (molded) into the front plate illustrated in FIG. 6 and a cell assembly illustrated in FIG. 3.

FIG. 13 is a perspective view for showing a rear structure of a front plate according to an embodiment of the present disclosure.

FIG. 14 is a diagram as a rear surface of the front plate of FIG. 3 is seen from a front region.

FIG. 15 is a diagram as the front plate of FIG. 13 is seen from above.

FIGS. 16 and 17 are diagrams schematically illustrating an inclined structure molded in a rear surface of a rear plate.

FIG. 18 is a front view as the rear plate illustrated in FIG. 3 is seen from the front.

### DETAILED DESCRIPTION OF EMBODIMENTS

Hereinafter, embodiments of the present disclosure will be described in detail with reference to the accompanying drawings.

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. In this disclosure, when an element is described as being connected to another element, the element may be directly connected to the other element, or a third element may be interposed therebetween. Also, in the drawings, a shape or a size of each element is exaggerated for convenience of a description and clarity, and elements irrelevant to a description are omitted. Like reference numerals refer to like elements throughout. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

In the following description, the technical terms are used only for explain a specific exemplary embodiment while not limiting the present disclosure.

The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

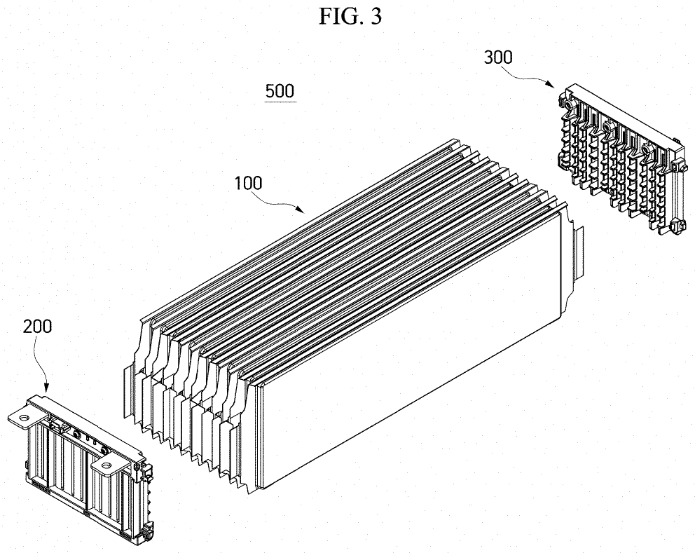

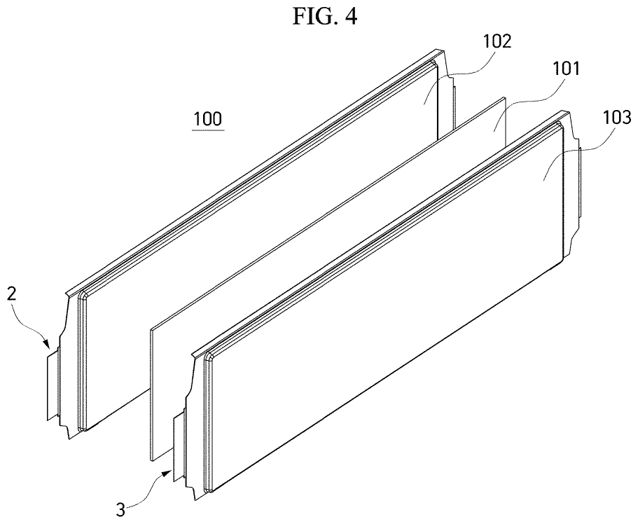

FIG. 3 is an exploded perspective view of a battery module assembly 500 according to an embodiment of the present disclosure, and FIG. 4 is a perspective view illustrating a unit structure of a cell assembly illustrated in FIG. 3.

Referring to FIG. 3, the battery module assembly 500 according to an embodiment of the present disclosure may include a cell assembly 100, a front plate 200, and a rear plate 300.

The cell assembly 100 may include a plurality of stacked pouch type of battery cells, and as illustrated in FIG. 4, may further include a pad 112 which is disposed between two adjacent battery cells of the battery cells.

The pad 101 may provide a surface pressure so that a plurality of battery cells 102 and 103 are closely adhered to each other. Each of the battery cells 102 and 103 may include a plurality of electrode lids 2 and 3 unloaded from both ends thereof.

The cell assembly 100 may be supported by a front plate 200 and a rear plate 300 which are respectively disposed in a front region and a rear region in a stacked direction.

Also, the electrode lid 2 of the battery cell 102 and the electrode lid 3 of the battery cell 103 may be connected to a bus bar assembly 207 integrated (molded) into the front plate 200 in series/parallel on the basis of an insert injection molding process.

Also, electrode lids (not clearly shown in FIG. 4), which are opposite to the electrode lids 2 and 3, of the battery cells 102 and 103 may be connected to the bus bar integrated into the rear plate 130 in series/parallel on the basis of the insert injection molding process

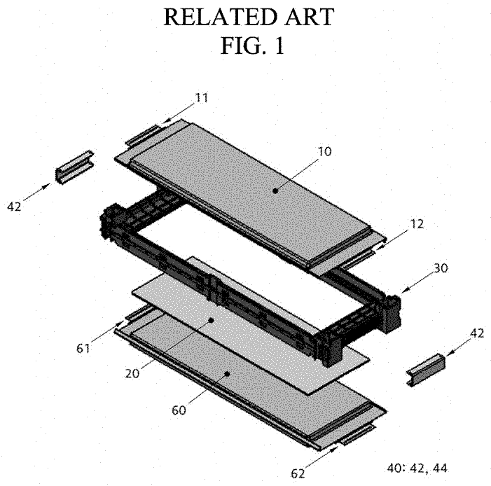

In the battery module assembly 500 according to an embodiment of the present disclosure, a separate cartridge (30 of FIG. 1) and separate bus bars 42 and 44 configuring the battery module assembly of the related art are not needed. This is because a function of the cartridge (30 of FIG. 1) and a function of the bus bars 42 and 44 are integrated into the front/rear plate 200/300 according to an embodiment of the present disclosure which will be described below.

As described above, in the battery module assembly 500 according to an embodiment of the present disclosure, because the cartridge (30 of FIG. 1) and the bus bars 42 and 44 of the related art are integrated into the front/rear plate 200/300, the number of elements, process complexity, weight, and a size may be reduced.

Hereinafter, a front plate and a rear plate will be described in detail.

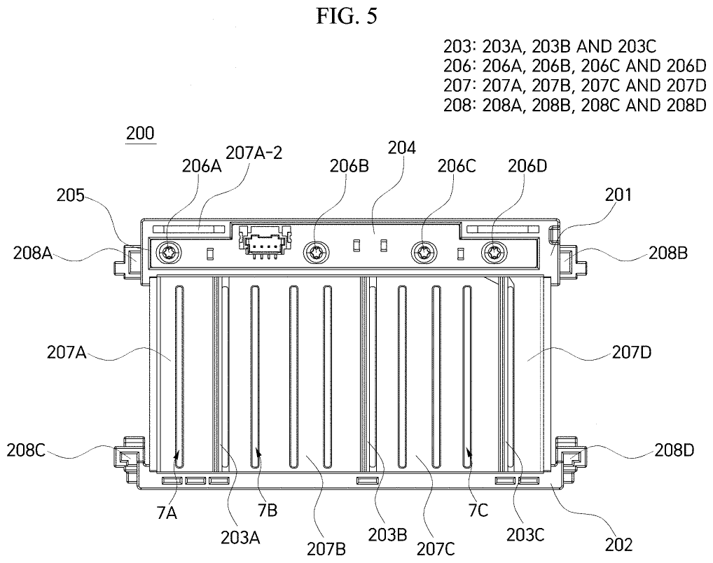

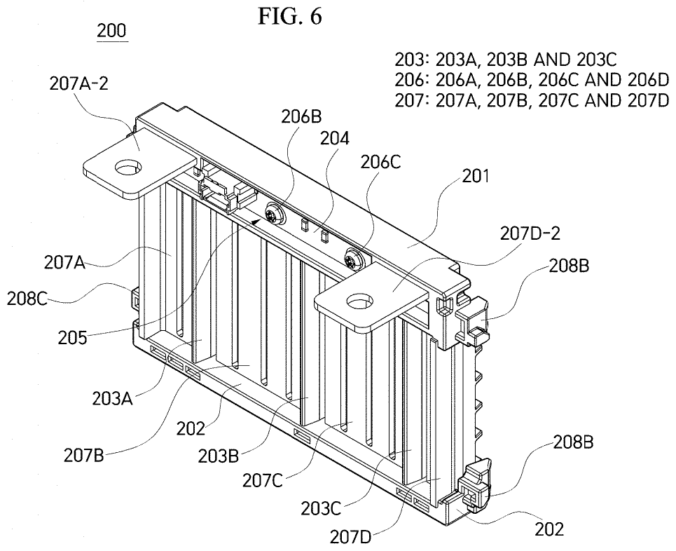

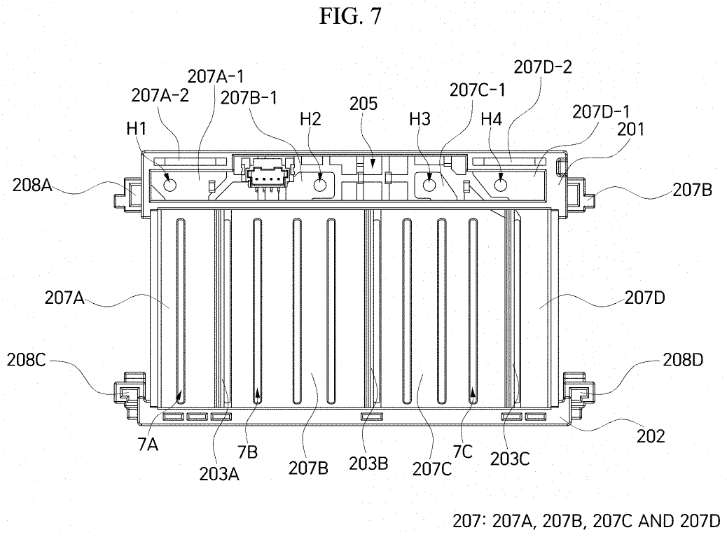

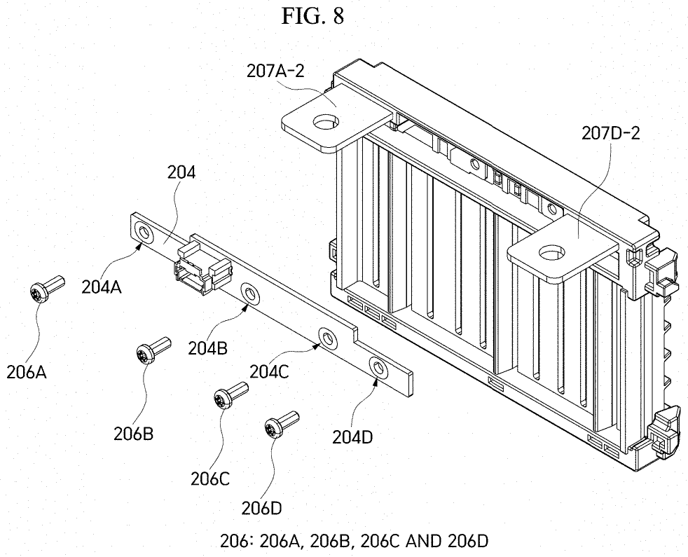

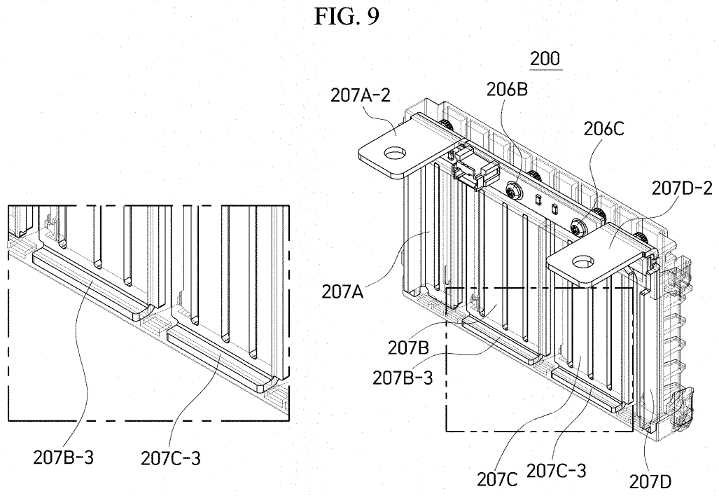

FIG. 5 is a front view as a front plate illustrated in FIG. 3 is seen from a front region. FIG. 6 is a perspective view for three-dimensionally showing a front plate illustrated in FIG. 5. FIG. 7 is a front view of a front plate in a state where a PCB is removed. FIG. 8 is a diagram for describing a coupling structure of a PCB and a front plate. FIG. 9 is a diagram illustrating an example where some structure materials of a front plate illustrated in FIG. 6 have been processed.

Referring to FIGS. 5 to 8, a front plate 120 may have a wholly tetragonal shape.

The front plate 200 may include an upper frame 201, a lower frame 202, a partition wall member 203 connecting the upper frame 201 to the lower frame 202, and a bus bar assembly 207.

The upper frame 201 may include a mounting space 205 which is formed based on a shape of a PCB 204. A plurality of electronic devices for processing voltage information about a battery cell may be mounted on the PCB 204, so as to provide another electronic unit of a vehicle with the voltage information about the battery cell.

The PCB 204 may be coupled to a bolt member 206 and a bus bar assembly 207 integrated (molded) into the front plate 200 on the basis of the insert injection molding process in a state where the PCB 204 is mounted in the mounting space 205.

The bolt member 206, as illustrated in FIG. 8, may be configured with four bolts 206A to 206D for example, and four coupling grooves 204A to 204D respectively coupled to the four bolts 206A to 206D may be provided in the PCB 204. Also, four coupling grooves (H1 to H4 of FIG. 7) may be provided in the bus bar assembly 207 disposed under the PCB 204.

The four bolts 206A to 206D may be coupled to the four coupling grooves 204A to 204D and the four coupling grooves (H1 to H4 of FIG. 7) and may couple the PCB 204 to the bus bar assembly 207.

As described above, the PCB 204 and the bus bar assembly 207 may be coupled to each other by a bolt coupling structure using the bolt member 206, and thus, when a defect occurs in a fuse or an element mounted on the PCB 204, the PCB 204 may be detached from a front plate (or an upper frame) and only a corresponding element of the PCB 204 may be replaced.

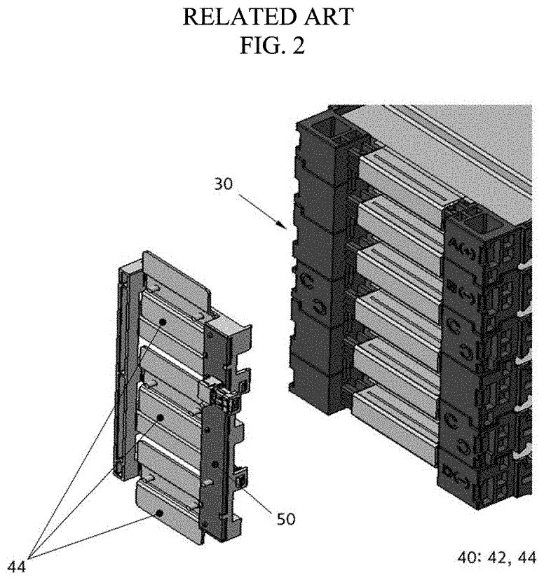

On the other hand, in the related art, as illustrated in FIG. 2, the PCB 50 may be coupled to the bus bar 44 by a soldering process, and thus, when a defect occurs in a corresponding element, a battery module may be discarded.

A stopper member 208 may be provided on both side surfaces of each of the upper frame 201 and the lower frame 202.

The stopper member, for example, may include two stoppers 208A and 208B provided on the both side surfaces of the upper frame 201 and two stoppers 208C and 208D provided on the both side surfaces of the lower frame 202.

The stopper member 208 may fix the front plate 200 to an end plate (not shown) so that a position of the bus bar assembly 207 is twisted, in coupling a cell assembly (100 of FIG. 3) to the bus bar assembly 207 integrated (molded) into the front plate 200.

The bus bar assembly 207 integrated (molded) into the front plate 200 may connect battery cells configuring the cell assembly 100 in series and parallel.

The bus bar assembly 207 may include four bus bars 207A to 207D which are disposed between the upper frame 201 and the lower frame 202 and are partitioned by the partition wall member 203 connecting the upper frame 201 to the lower frame 202.

A first bus bar 207A may be implemented in a tetragonal plate shape and may include a slit hole 7A through which an electrode lid (2 or 3 of FIG. 4) passes. The slit hole 7A may be formed in a lengthwise direction.

Moreover, the first bus bar 207A may further include a coupling member 207A-1 which extends toward the mounting space 205 of the upper frame 201 from an upper end thereof. A coupling groove H1 coupled to the above-described bolt 206A may be formed in the coupling member 207A-1.

Moreover, the coupling member 207A-1 may further include a terminal member 207A-2 which is bent vertically from an end portion thereof. The terminal member 207A-2 may electrically connect the battery module assembly according to an embodiment of the present disclosure to another battery module assembly (not shown).

The coupling member 207A-1 and the terminal member 207A-2, as illustrated, may be disposed as a type which is molded in the upper frame 201.

A second bus bar 207B may be implemented in a tetragonal plate shape and may be insulated from the first bus bar 207A by a first partition wall 203A. The second bus bar 207B may include at least one slit hole 7B through which an electrode lid passes. The slit hole 7B may be formed in a lengthwise direction.

Moreover, the second bus bar 207B may further include a coupling member 207B-1 which extends toward the mounting space 205 of the upper frame 201 from an upper end thereof. A coupling groove H2 coupled to the above-described bolt 206B may be formed in the coupling member 207B-1.

A third bus bar 207C may be implemented in a tetragonal plate shape and may be insulated from the second bus bar 207B by a second partition wall 203B. The third bus bar 207C may include at least one slit hole 7C through which an electrode lid passes. The slit hole 7C may be formed in a lengthwise direction.

Moreover, the third bus bar 207C may further include a coupling member 207C-1 which extends toward the mounting space 205 of the upper frame 201 from an upper end thereof. A coupling groove H3 coupled to the above-described bolt 206C may be formed in the coupling member 207C-1.

A fourth bus bar 207D may be implemented in a tetragonal plate shape and may be insulated from the third bus bar 207C by a third partition wall 203C. In FIGS. 5 and 7, it is illustrated that a slit groove is not formed in the fourth bus bar 207D, but a slit groove may also be formed in the fourth bus bar 207D.

The fourth bus bar 207D may further include a coupling member 207D-1 which extends toward the mounting space 205 of the upper frame 201 from an upper end thereof. A coupling groove H4 coupled to the above-described bolt 206D may be formed in the coupling member 207D-1.

The coupling member 207D-1 may further include a terminal member 207D-2 which is bent vertically from an end portion thereof with respect to the coupling member 207A-1. The terminal member 207D-2 may electrically connect the battery module assembly according to an embodiment of the present disclosure to another battery module assembly (not shown).

Moreover, as illustrated in FIG. 9, unlike the first and fourth bus bars 207A and 207D, the second and third bus bars 207B and 207C may further include extension portions 207B-3 and 207C-3 which are bent vertically from a lower end thereof, respectively.

The extension portions 207B-3 and 207C-3 may be disposed as a type which is integrated (molded) into the lower frame 202.

The extension portions 207B-3 and 207C-3 may increase a square SQ of the second and third bus bars 207B and 207C. Resistance values of the extension portions 207B-3 and 207C-3 may be reduced by the extension portions 207B-3 and 207C-3.

The first and fourth bus bars 207A and 207D may respectively include the terminal members 207A-2 and 207D-2 which extend vertically with respect to the coupling members 207A-1 and 207D-1, and thus, may form a sufficient square. Accordingly, the first and fourth bus bars 207A and 207D may not need a structure material such as the extension portions 207B-3 and 207C-3 included in the second and third bus bars 207B and 207C.

FIGS. 10 to 12 are diagrams for describing an electrode connection structure of a bus assembly integrated (molded) into the front plate illustrated in FIG. 6 and a cell assembly illustrated in FIG. 3.

As illustrated in FIG. 10, when manufacturing of a front plate 200 is completed, the front plate 200 may move toward an electrode lid of a cell assembly 100.

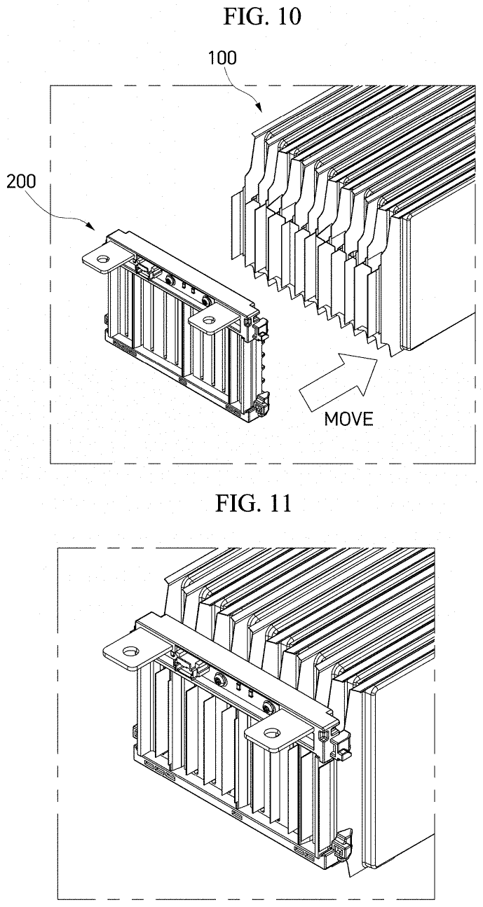

Subsequently, as illustrated in FIG. 11, electrode lids respectively unloaded from battery cells configuring the cell assembly 100 may be inserted into slit holes 7A to 7C of bus bar assemblies 207 (207A to 207D).

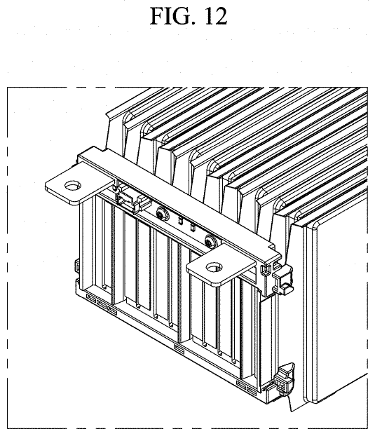

Subsequently, as illustrated in FIG. 12, the electrode lids inserted into the slit holes 7A to 7C may be bent, and the bent electrode lids may be adhered and welded to the bus bar assemblies 207 (207A to 207D).

Therefore, the battery cells configuring the cell assembly 100 may be connected to one another in series and parallel by using the bus bar assemblies 207 (207A to 207D) integrated (molded) into the front plate 200.

A rear surface of the front plate 200 may be molded in an inclined structure so that the electrode lids respectively unloaded from the battery cells are easily inserted into the slit holes 7A to 7C.

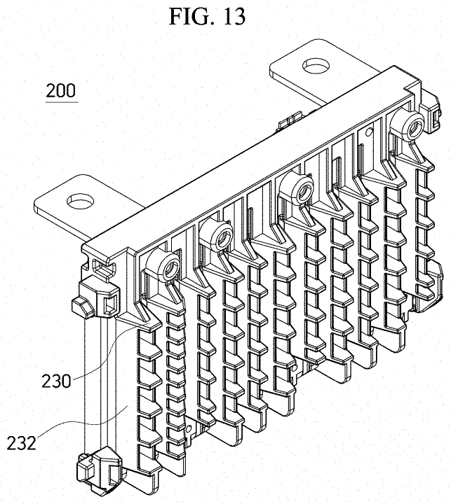

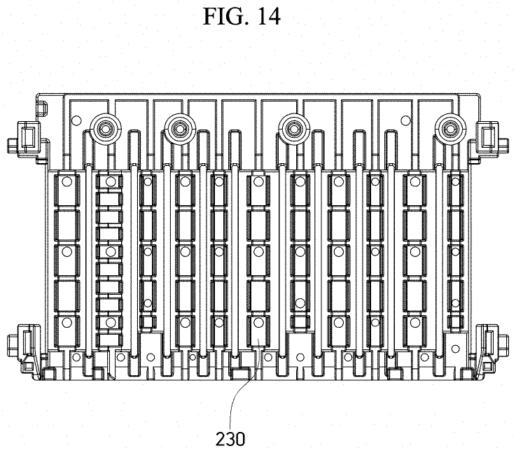

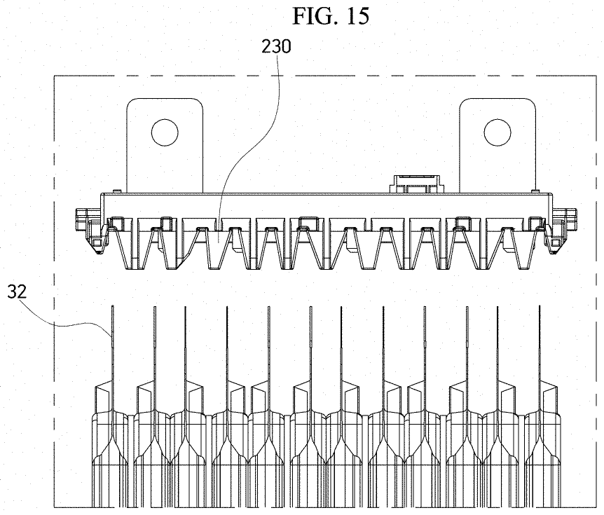

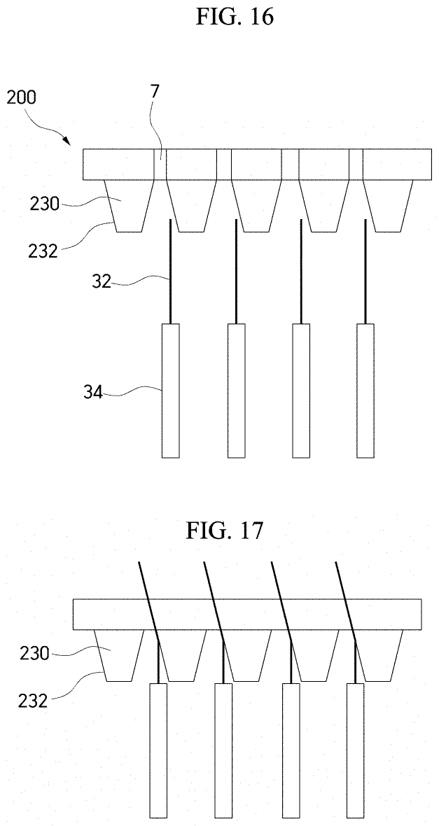

FIG. 13 is a perspective view for showing a rear structure of a front plate according to an embodiment of the present disclosure. FIG. 14 is a diagram as a rear surface of the front plate of FIG. 3 is seen from a front region. FIG. 15 is a diagram as the front plate of FIG. 13 is seen from above. FIGS. 16 and 17 are diagrams schematically illustrating an inclined structure molded in a rear surface of a plate.

Referring to FIGS. 13 to 15, a guide member 230 for enabling electrode lids respectively unloaded from battery cells to be easily inserted into slit holes 7A to 7C may be provided on a rear surface of a front plate 200.

The guide member 230 may extend in a lengthwise direction with a slit groove, formed in the bus bar assembly 207, therebetween. An inclined surface 232 inclined in an insertion direction of an electrode lid may be provided on both side surfaces of the guide member 230.

As illustrated in FIG. 16, a state where an electrode lid 32 of a battery cell 34 extends rectilinearly may be maintained before the battery cell 34 is inserted into a slit hole 7.

Subsequently, as illustrated in FIG. 17, the electrode lid 32 of the battery cell 34 may be naturally inserted into the slit hole 7 along the inclined surface 232. The guide member 230 for enabling the electrode lids respectively unloaded from the battery cells to be easily inserted into the slit holes 7A to 7C may be provided on the rear surface of the front plate 200, and thus, the damage of a cell assembly (the damage of an electrode) may be prevented from occurring in coupling the cell assembly to a bus bar assembly.

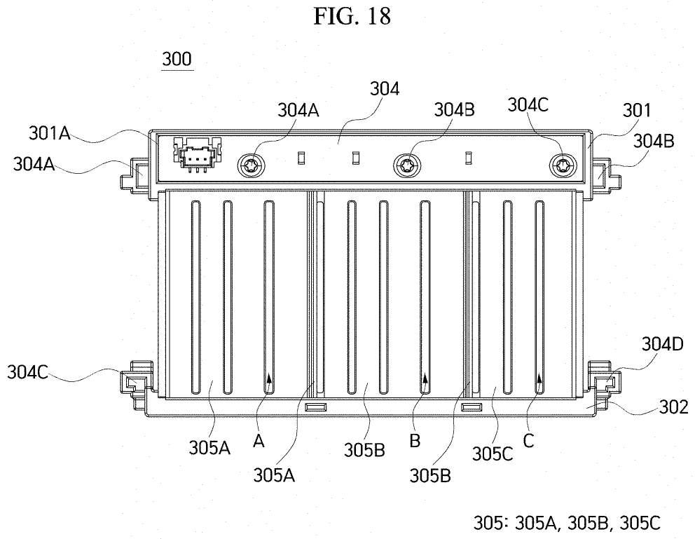

FIG. 18 is a front view as the rear plate illustrated in FIG. 3 is seen from the front.

Referring to FIG. 18, a rear plate 300 may include an upper frame 301, a lower frame 302, and a plurality of partition wall members 303A and 303B connecting the upper frame 301 to the lower frame 302.

Moreover, the rear plate 300 may further include a PCB 304 mounted in a mounting space 301A formed in the upper frame 301. The PCB 304 may be an element which transfers voltage information about a battery cell to an external unit of a vehicle, and to this end, a plurality of electronic devices for processing the voltage information may be mounted on the PCB 304.

The PCB 204 may be coupled to bus bar assemblies 305A to 305C by using bolt members 304A to 304C in a state where the PCB 304 is mounted in the mounting space 301A.

A plurality of stopper members 304A to 304D may be provided on both side surfaces of each of the upper frame 301 and the lower frame 302. The stopper members 304A to 304D, like the above description of the front plate 200, may fix the rear plate 300 to an end plate (not shown) so that a position of the bus bar assembly 305 is not twisted, in coupling a cell assembly (100 of FIG. 3) to the bus bar assembly 305 integrated (molded) into the rear plate 300.

Moreover, the rear plate 300 may further include a bus bar assembly 305 which connects in series and parallel electrode lids (2 or 3 of FIG. 4) respectively unloaded from a plurality of battery cells included in a cell assembly (100 of FIG. 3). In this case, the bus bar assembly 305 may be provided as a type which is integrated (molded) into the rear plate 300 on the basis of the insert injection molding process.

The bus bar assembly 305 may include first to third bus bars 305A to 305C having a tetragonal plate shape.

Each of the first to third bus bars 305A to 305C may be implemented in a tetragonal plate shape and may include at least one slit hole A, B, or C formed in a lengthwise direction.

The slit hole A, B, or C may be formed in a lengthwise direction.

The electrode lid unloaded from each of the battery cells may be inserted into the slit hole A, B, or C, the electrode lids inserted into the slit holes A, B, and C may be bent, and the bent electrode lids may be respectively adhered and welded to the first to third bus bars 305A to 305C.

Moreover, although not shown, a guide member including the same inclined surface as a rear structure of the front plate 200 may be provided in the rear plate 300, and thus, the rear plate 300 may be naturally inserted into each of the slit holes A, B, and C along the inclined surface in a process of inserting the electrode lids into the slit holes A, B, and C.

As described above, a configuration and a shape of the rear plate 300 may be similar to a configuration and a shape of the front plate 200 described above with reference to FIGS. 5 to 17. Therefore, a detailed description of the rear plate 300 may be applied to a description of the front plate 200. However, the bus bars 305A to 305C integrated into the rear plate 300 may have a difference in that the bus bars 305A to 305C do not include the terminal members 207A-2 and 207D-2 provided in the bus bars 207A and 207D integrated into the front plate 200.

Because the bus bars 305A to 305C integrated into the rear plate 300 do not include a terminal member, all of the bus bars 305A to 305C may be configured to include the extension portions 207B-3 and 207-C illustrated in FIG. 9, so as to decrease a resistance value of a bus bar (to increase a square SQ).

That is, in the front plate 200, the bus bars 207B and 207C disposed at a middle portion may be implemented to include an extension portion which extends vertically from a lower end portion thereof, but in the rear plate 300, all of the bus bars 305A to 305C may be implemented to include an extension portion which extends vertically from a lower end portion thereof.

According to the embodiments of the present disclosure, the battery module assembly may be implemented without elements such as a bus bar and a cartridge of the related art, and thus, an assembly process may be simplified and the number of elements may be reduced, thereby reducing the cost and decreasing weight.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A battery module assembly comprising:
a cell assembly including a plurality of battery cells which are stacked; and
a front plate and a rear plate supporting the cell assembly in a front region and a rear region in a direction in which the plurality of battery cells are stacked,
wherein:
each of the front plate and the rear plate comprises:
an upper frame;
a lower frame; and
a plurality of bus bars disposed between the upper frame and the lower frame and having a tetragonal plate shape,
each of the plurality of bus bars comprises a slit groove extending in a lengthwise direction, and
each of the plurality of battery cells includes an electrode lid inserted into the slit groove, bent to be adhered to a corresponding bus bar of the plurality of bus bars, and connected to the corresponding bus bar by a welding process in an adhered state.

2. The battery module assembly of claim 1, wherein the upper frame comprises a mounting space where a printed circuit board for transferring voltage information about each battery cell to an external unit of a vehicle is mounted.

3. The battery module assembly of claim 2, wherein
each of the plurality of bus bars further comprises a coupling member extending to the mounting space of the upper frame, and
the printed circuit board is coupled to the coupling member by a bolt member.

4. The battery module assembly of claim 3, wherein at least two of the plurality of bus bars further comprise a terminal member bent vertically at an end portion of the coupling member, for electrically connecting the battery module assembly to another battery module assembly.

5. The battery module assembly of claim 1, further comprising a plurality of partition walls connecting the upper frame to the lower frame,
wherein the plurality of bus bars are insulated from one another by the plurality of partition walls.

6. The battery module assembly of claim 1, wherein
a guide member, configured to guide an electrode lid protruding from each battery cell to be inserted into the slit groove, is disposed in a rear surface of each of the front plate and the rear plate, and
the guide member comprises an inclined surface on two side surfaces of the guide member to extend in the lengthwise direction, the inclined surface being inclined in a direction in which the electrode lid is inserted.

7. The battery module assembly of claim 1, wherein the upper frame, the lower frame, and the plurality of bus bars are formed as one body by an insert injection molding process.

8. A battery module assembly comprising:
a cell assembly including a plurality of battery cells which are stacked; and
a front plate and a rear plate supporting the cell assembly in a front region and a rear region in a direction in which the plurality of battery cells are stacked,
wherein
each of the front plate and the rear plate comprises:
an upper frame;
a lower frame;
a plurality of partition walls connecting the upper frame to the lower frame; and
a plurality of bus bars disposed between the upper frame and the lower frame, having a tetragonal plate shape, and insulated by the plurality of partition walls,
each of the plurality of bus bars comprises a slit groove extending in a lengthwise direction,
each of the plurality of battery cells includes an electrode lid inserted into the slit groove, bent to be adhered to a corresponding bus bar of the plurality of bus bars, and connected to the corresponding bus bar by a welding process in an adhered state, and
at least two of the plurality of bus bars each comprise an extension portion bent vertically from a lower end portion of a corresponding one of the at least two of the plurality of bus bars, for increasing a square.

9. The battery module assembly of claim 8, wherein the extension portion is molded in the lower frame.

10. The battery module assembly of claim 8, wherein
some of the plurality of bus bars included in the front plate each comprise a terminal member bent from an upper end portion of the front plate and molded in the upper frame, and
the at least two bus bars including the extension portions are different bus bars from the bus bars including the terminal members.

11. The battery module assembly of claim 8, wherein each of the plurality of bus bars included in the rear plate comprises the extension portion.

12. The battery module assembly of claim 8, wherein the upper frame comprises a mounting space where a printed circuit board for transferring voltage information about each battery cell to an external unit of a vehicle is mounted.

13. The battery module assembly of claim 12, wherein
each of the plurality of bus bars further comprises a coupling member extending to the mounting space of the upper frame, and
the printed circuit board is coupled to the coupling member by a bolt member.

14. The battery module assembly of claim 8, wherein
a guide member, configured to guide an electrode lid protruding from each battery cell to be inserted into the slit groove, is disposed in a rear surface of each of the front plate and the rear plate, and
the guide member comprises an inclined surface on two side surfaces of the guide member to extend in the lengthwise direction, the inclined surface being inclined in a direction in which the electrode lid is inserted.

15. The battery module assembly of claim 8, further comprising a stopper member disposed on each of two side surfaces of each of the upper frame and the lower frame,
wherein the stopper member is configured to fix the front plate and the rear plate to an end plate so that positions of the plurality of bus bars are not twisted, in coupling the cell assembly to the plurality of bus bars molded in each of the upper frame and the lower frame.
